(19) United States
(12) Patent Application Publication
(10) Pub. No.: US 2002/0128858 A1
(43) Pub. Date: Sep. 12, 2002

(54) Method and system for population classification

(76) Inventor: Douglas Neal Fuller, Stone Mountain, GA (US)

Correspondence Address: Dr. Douglas Neal Fuller, P.O. Box 450936, Atlanta, GA, 31145-0936, US

(21) Appl. No.: 10/038,977

(22) Filed: Dec. 31, 2001

Related U.S. Application Data
(60) Provisional application No. 60/260,128, filed on Jan. 6, 2001.

(51) Int. Cl. G06F 17/60

(52) U.S. Cl. 705/1

(57) ABSTRACT

A method and system for classifying populations, with largely unknown distribution characteristics, to enable the forecasting of behavior of the population under study. The invention utilizes mixture-modeling methods combined with classification techniques. The population under study is divided into component homogeneous sub-populations through the use of a mixing variable. This variable is a data element or characteristic of the population under study that is believed to reflect differences among an unknown number of sub-populations which result in a non-homogenous mixed population. Next the population under study is augmented with proportional assignments from the sub-populations and assignment rules are generated for the members of the population. Once assignment rules are generated, new members can be added to the population and longitudinal forecasting of the population behaviors can commence. The invention also includes a Fuller Penalized Chi Squared statistic that is beneficial when formulating the optimal number of sub-population constituents of the population under study. Statistically valid error boundaries around the resultant forecasts are also enabled in this invention. Therefore confidence limits can be included with the behavior forecasts, thus increasing the predictive power.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States patent and Trademark Office patent file or records, but otherwise reserves all copyright rights whatsoever.

### CROSS REFERENCE TO RELATED APPLICATIONS

This is non-provisional application is based on the provisional patent application Ser. No. 60/260,128 [pending] to Douglas Fuller, for “Exploration of Population Classification for Managed Healthcare with a State-based Modeling Framework” filed Jan. 6, 2001, which is incorporated hereinto in its entirety by reference.

### FIELD OF THE INVENTION

The invention relates generally to the field of population classification.

### BACKGROUND OF THE INVENTION

There is a desire to group like component parts of a population into meaningful segments so that “control” strategies can be implemented. Two examples of this desire can be found in the managed healthcare and credit card industries. In these industries, a sample drawn from a general population of customers is typically comprised of some number of sub-populations which have distinct differences in attributes including propensities, requirements and responses. Often times the differences are unknown, thereby causing a problems defining the sub-populations. Today these problems are often “solved” by using qualitative segment attributes; for example heavyset people are more likely to develop diabetes, people in stressful work or personal situations are more likely to develop heart ailments.

Our societal and public policy needs demand a more quantifiable approach for such a population sample of largely unknown attributes. In order to efficiently manage this population sample, it would be desirable to assign each individual of the sample to its respective sub-population and then define an optimal control strategy for each sub-population. However, at the heart of all current methods of classification is an assumption that either the sample be representative of a homogeneous population or that the differing attributes among the various non-homogeneous sub-populations be sufficiently characterized so that the classification methodology can be adjusted to compensate for these differences among the various non-homogeneous sub-populations. Unfortunately, this assumption of either a homogenous population or qualitatively characterizable attribute differences between sub-populations can lead to costly errors in management of the population.

In some environments, this problem can be overcome by pre-defining sub-population attributes and finding representative samples of each. From this basis, historical data is gathered and a classification scheme archetype is created by developing assignment rules that link patterns in the historical data to these archetypes. As such, when a previously unassigned individual is considered, that individual is assigned by the developed classification rules.

However, in many cases where new population classification is required, there exist no appropriate archetype that can be predefined. One example is a meaningful whole-life cost groupings for managed healthcare. In these cases, there have been repeated examples of attempting to perform classification without addressing the issue of these non-homogenous sub-populations. The attempts have ended with application results vastly different from the actual sample result. Furthermore, owing to the violated assumption regarding homogeneity, it is impossible to develop valid error bounds or confidence intervals that can accurately guide the amount of variance expected from a prediction.

Such an environment, i.e., there is at least the belief of the existence of multiple non-homogenous sub-populations about which little is known. Such an environment represents a preferred domain in which this invention would be applied.

### BRIEF DESCRIPTION OF THE DRAWINGS

FIG. 1 shows a simplified representative flow chart of the present invention.

FIG. 2 shows a more detailed flow chart of a method of the present invention.

FIG. 3 shows a block diagram of a system of the present invention.

FIG. 4-FIG. 7B shows applications of the Fuller Penalized Chi Square statistic.

### BRIEF SUMMARY OF THE INVENTION

This is a non-limiting brief summary of the invention. Other features, advantages and operations of the invention may be described in greater detail in the foregoing description and incorporated reference.

The invention provides a method of population classification and assignment that generates behavior forecasts of current and new individuals in the population, the method includes the steps of: receiving a sample population dataset, selecting a mixing variable, using classical statistical processes to yield a variety of sub-population characterizations, selecting optimum sub-population mixture, augmenting the sample population dataset with proportional assignments, using standard classification processes to yield assignment rules, and assigning individuals to a unique sub-population.

The method uses a continuous variable within the population dataset to develop estimates of sub-population composition. This variable is the mixing variable. At times multiple continuous variables are contained in the sample population dataset. In these cases multiple iterations of the mixing process may facilitate a convergence on a statistically optimum sub-population mixture. Where multiple mixing variables are found, all mixing variables can be used to augment the sample population dataset to add sub-population proportional assignments for each individual member of the population.

The method will typically require multiple iterations to successfully develop the assignment rules for individuals in the sample population dataset. Once completed, or converged, however the resultant is a powerful set of rules to forecast behavior of the population. This includes the ability to add new individuals to the population as well as account for current individuals who may be removed from the population.

The method is preferably utilized when the population of interest comprises representatives from an unknown number of non-homogeneous sub-populations. If the suspected non-homogenous population turns out to be homogeneous, all resultants are still statistically valid. The method and system will also work for known, homogeneous sub-populations though a mathematically intensive approach under those circumstances.

The method requires no assumptions regarding the number, proportions or parameters by which the various sub-populations are distributed and develops estimates of the distribution parameters for each of the sub-populations.

The method works with a minimal assumption set of a mixing variable (or variables) which reflect(s) differences among the sub-populations and an assumption regarding the distributional form of expected responses from the various sub-populations. Sub-populations can have different distribution trends (i.e. normal, exponential, etc.) and the method is still valid. A baseline assumption in the method however, is that all sub-populations do follow some distribution form. The method allows a stochastic assignment of each individual to the developed sub-populations and employs an iterative approach on an augmented data set to assign individuals to the proper component sub-population. The method allows the creation of assignment rules to facilitate the association of a new individual to the proper component sub-population and creates estimates for of the expected value of the response variable for a previously unknown group of individuals. The method utilizes the derived classification to develop management strategies for the each identified sub-population.

The invention also includes a system for population classification that generates behavior forecasts of the population, comprising: a storage device for system memory, an estimation processor, an evaluation processor, an a priori classification processor, a posterior classification processor, and a final classification processor. The system may be implemented as hardware, firmware or software or a combination of the three. The storage device contains the initial sample population dataset. Additional memory added during processing includes; the mixture estimate, the augmented dataset, and the assignment rules. The estimation processor contains; the iteration control, the sub-population count generator, the distribution form generator, and the distribution parameter generator. The evaluation processor contains; the metrics comparison processor, the estimated metrics generator and the sample metrics generator. The a priori classification processor contains; the inverse probability generator and the stochastic classification generator. The posterior classification processor contains; an iteration control module, an individual assignment generator and an assignment rule generator.

An extension of the prior art of finite mixture models utilizing the Fuller Penalized Chi Square technique to build on Pearson's Chi Square with an added component representative of the number of parameters and sub-populations derived from the population. The importance of this modification is that it enables for the first time, the use of computationally simpler Chi Squared optimization methods to be applied in a statistically valid way to such mixture problems as covered by the invention.

Pearson's Chi Square is represented as:

$${X}^{2} = {\sum }_{k} {( {O}_{k} - {E}_{k} )}^{2} / {E}_{k}$$

Eₖ=Expected samples in block k, k=1 to r

r=# of blocks in the histogram

k=# of sub-populations

Fuller's Penalized Chi Square is represented as:

pX²=X²+G

where G=a penalty factor proportional to the # of estimated parameters.

This method allows evaluation of a number of sub-population estimates to derive the optimal solution from the list of generated candidates and also allows the selection over minimal valid number while avoiding issues of model “overfit”. This method develops a statistically valid estimate of the number of sub-populations present and develops a statistically valid estimate of the mixing proportions of these sub-populations. This method provides statistically valid parametric estimates of each sub-population and allows definition of conditional probabilities of individual assignments in the defined sub-population using the a priori processor. A statistically valid error boundary or confidence limit can be constructed around the predicted value of the system. This enables the user of the system to know the percent certainty of the results provided.

### DETAILED DESCRIPTION OF THE PREFERRED EMBODIMENT

The following terms are used herein:

Stochastic—is a probabilistic statement of membership (likelihood) rather than specific assignment.

Heuristic—is a method that tends to give “good” results without proof of optimality.

Parameter—is a variable that defines the shape and spread of a distribution (e.g., the normal distribution is defined by its mean and variance, as such, the mean and variance would represent the parameters of a normal distribution).

non-Homogeneous—is a condition created by mixing populations comprising different variances around the measured statistic.

Continuous variable —is one for which, within the limits the variable ranges, any value is possible. For example, for annual health care costs in dollars, the variable would have a range from zero dollars to several million dollars, but all intervening numbers are possible realizations for a member.

Population—is the entire collection of members this is the focus of concern.

Sample population—is a selection of members of a number that is less than or equal to the number of members in the Population that have characteristic distributions representative of the population as a whole.

Sub-population—is a grouping of members from a Population or Sample Population of a number that is less than or equal to the number of members in the Population or Sample Population and further, represent a homogenous grouping of the mixing characteristic. The collection members of defined sub-populations comprise the members of the Population or Sample Population as a whole and the unique assignment of a member to one sub-population excludes that member from assignment to any of the other defined sub-populations.

Sub-population model overfit—is a condition that arises when a Population or Sample Population is divided into a number of sub-populations that is necessary to insure homogenous grouping required by the definition of a Sub-population.

Sub-population mixing proportions—are the number of members of a component sub-population when expressed as a proportion of the number of members of the Population or Sample Population as a whole.

Sub-population parametric estimates—are the collection of realizations of the mixing characteristic of a sub-population that is assumed to follow a probability distribution. This distribution defines the probability that any given realization will be less than or equal to a specified number. The parameters of a distribution are the statistics sufficient to wholly describe the expected behavior of that distribution. For example, a characteristic that follows a normal distribution can be fully defined by specifying the parameters of the mean and standard deviation.

Dataset categories—are substantially the same thing as characteristics or factors or variables or element. Basically it is field or element in the dataset which has the value or realization for the given member. For example, it could be age or gender or number of prescriptions received in the past year.

The publication “An Exploration of Population Classification for Managed Healthcare with a State-based Modeling Framework”, January 2000, by Douglas N. Fuller which may be at least found at the University of Virginia library Diss.Engr.2000.F84 (card cat id) provides a detailed description of components of the invention and is hereby incorporated by reference.

The invention provides analytical methods for the meaningful segmentation of unknown non-homogenous populations. In particular the invention includes a system and methodology allowing the analysis of non-homogenous populations in a wide range of fields to be assigned to meaningful sub-populations without prior knowledge of the number, proportions and group characteristics of the non-homogenous population. This is done with a combination of heuristic and mixture methods to yield defined sub-populations which, in turn, are used to augment the original population and derive an assignment set of rules. This set of assignment rules, permits classification of individuals within the population to a unique sub-population. This process then accommodates inflow and outflow of individuals from the population, as may occur for instance in a longitudinal study. Further, non-homogenous population behavior can be forecast based on the historical patterns inherent in the classification of the sub-populations leading to a wide number of uses in the optimization of forecasts for populations.

The invention also includes an improved extension of the use of Chi Squared testing. The Chi Squared statistic has previously proved inaccurate in mixture methods for non-homogenous populations. By adding a complexity penalty to the Chi Square statistic the validity of its use is significantly improved. The penalty is related to the number of sub-populations optimally established and the number of parameters measured within each sub-population.

Finally the invention includes the capability to have statistically valid error boundaries around the forecasted behaviors. The substantial absence of this capability today is in no small way contributing to the demise of preset fee capitation rates in the United States healthcare system. An error bound is a statistical statement of confidence regarding the possible difference between a predicted value and the actual realization. For example, a model may predict an average cost per patient of $125 and be able to state with 95% confidence that this figure will be correct within +/−$10. In this case, it could be expected that in 19 years out of 20, the average cost per patient would range between $115 and $135. However, if the underlying assumptions for creating estimated model are not fulfilled (e.g. due to the presence of non-homogenous sub-populations), the statement of +/−$10 could not be counted on to hold in 19 out of 20 years.

In any business environment, healthcare included, the ability to rely on the accuracy of estimates regarding costs or revenues is critical to being able to successfully implement a set fee capitation plan. There are a number of documented cases in which a capitation based rate plan has been discarded because the actual difference between projected and experienced delivery costs has far exceeded the predicted boundaries. One example of this is when a major provider of managed care in Maryland announced that they were reverting from capitation structure in their existing physician contracts to a discounted fee for service basis.

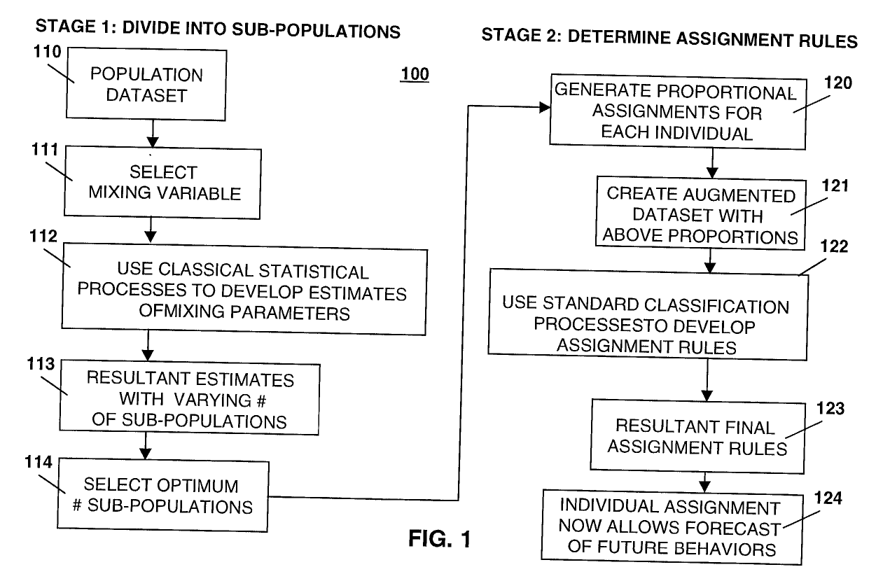

Referring to FIG. 1, a method 100 of classifying a population that permits the population of interest to be segmented into meaningful sub-populations based on available data even though the number, proportions and group characteristics are unknown to the practitioner in advance. Method 100 analyzes the population of interest in two major stages. The first stage (Stage 1), steps 110-114 transforms the originally provided sample population dataset into an optimum set of sub-populations representing the mixture within the population. Step 110 represents the population dataset presented for analysis. The dataset includes a number of variables for each member of the population including at least one continuous variable.

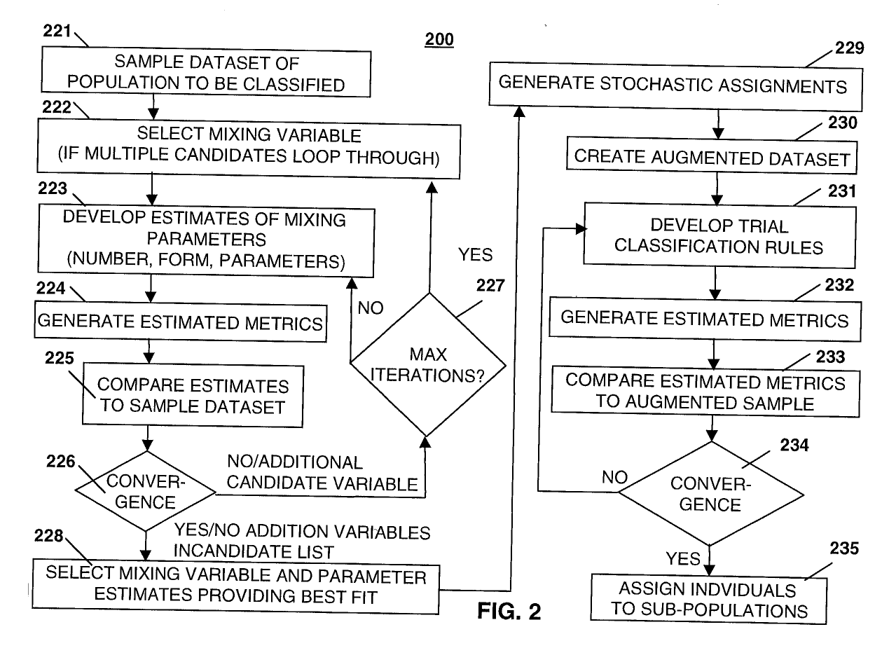

In step 111 a continuous variable within the dataset is used as a mixing variable. An example continuous variable could be account balance or annual income for a credit card dataset or annual healthcare cost or age in a medical dataset. This mixing variable is used in step 112 to create a number of estimated sub-population mixtures. A further description of the methods used in step 112 is contained in reference to FIG. 2.

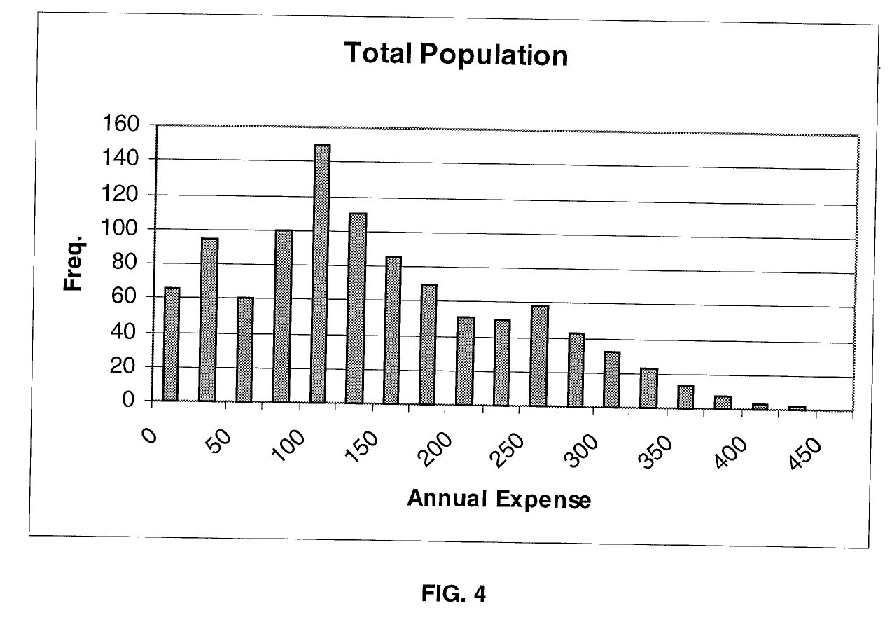

Step 113 is representative of the various sub-population estimates generated in step 112. Often a range of quantity of sub-populations will be selected for the estimate. For example, step 113 could generate mixtures with 2, 3 or 4 sub-population within the dataset. One of several statistical methods are applied in step 114 to select the representative sub-population with the “best fit” to the original population dataset. One method to make this selection could be the Fuller Penalized Chi Square statistic which is described with respect to FIG. 4 through FIG. 7 and discussed in more detail below.

Next, with an optimum sub-population representation we proceed to steps 120-124, to the second stage of the method. Stage 2 in FIG. 1 is where assignment rules are determined and individuals in the dataset mixing variable selected at step 111 are assigned to a unique sub-population. In step 120 the sub-population mixture chosen in step 114 is used to generate proportional assignments for each individual in the sample population dataset. For example, an individual may have a 10% chance of being in sub-population 1, a 20% chance of being in sub-population 2, a 30% chance in sub-population 3 and a 40% chance of being in sub-population 4 at this step 120. In step 121 these proportional assignments for each individual are added into the original population dataset.

At this point the richest or most extensive amount of data available for the population dataset is desirable. In step 122 the iterations begin to identify valid assignment rules for an augmented dataset. The augmented data set comprises the individuals of the original dataset wherein each individual has proportional assignments for each sub-population. More detail of this processes in this step are discussed below in reference to FIG. 2. The resultant final assignment rules are represented in step 123. These final assignment rules will likely use only a sub-set of the dataset categories available however a data rich starting point is desired as the significant categories are likely not known prior to this analysis. The statistically significant categories resultant in the final assignment rules of step 123 can now be used as a “going forward” baseline assignment for new individuals to be added to the population.

All current individuals of the population can now be assigned to a unique sub-population. Additionally, inflow and outflow of individuals in the population can now be accounted for in the method as represented in step 124. By establishing these optimum sub-populations, the behavior of interest can be forecast.

Additionally, this method enables the production of error bounds or confidence limits around forecasted behaviors. This can prove to be critically important in operationalizing the method. For example, annual healthcare costs of say sub-population 3 can be projected at $150 plus or minus 5% next year while sub-population 4 will have a projected costs of $225 plus or minus 8%. Accurate projection information is vitally important to the healthcare industry.

Referring to FIG. 2, method 200 is a more detailed view of the population classification of FIG. 1. In particular, the method 200 utilizes the properties observed in a selected continuous response variable to create an a priori stochastic estimate of sub-population membership. This stochastic assignment can then be included as an input to a secondary assignment procedure to develop rules for individual assignment without violating the assumptions required by currently available methods of classifications. This is useful because the methods of this invention yield a resultant that can then be applied to traditional classification problems which are known to those familiar with the art.

In step 221 a sample dataset of factors, or categories, which are suspected as being relevant to the population of interest is assembled. This dataset categories may be comprised of qualitative or quantitative variables. For example, color of eyes or hair or the fact of a family history of heart disease, are qualitative while age and annual expenses are quantitative. The quantitative variables must include at least one continuous variable believed to represent a response in which the differences of sub-populations would be recognized. This continuous variable is known as the mixing variable. In step 221, elements, features and/or measurements best representing the population and application in question are decided.

In step 222, a list of potential mixing variables is created and the first candidate mixing variable is selected. In step 223, a second level, or embedded iteration is begun in which successive estimated parameters of the number, relative proportions and group characteristics of the sub-populations are created. This series of estimated parameters can be generated by any manner of heuristic search or statistical exploration methodology as selected by the practitioner. Sample methodologies would include the Estimation Maximization (E-M) algorithm or the Fuller Penalized Chi Squared approach as described in more detail below.

In step 224, the estimated parameters from step 223 are used to generate descriptive statistics for a sample of size equal to the number of members in the dataset. In step 225, a metric based on these estimated descriptive statistics is compared to the actual descriptive statistics for the dataset.

In step 226, the comparison of step 225 is checked for convergence in which a pre-determined measure of likeness to a pre-selected figure of merit representing the margin of error or acceptable difference. In most cases this check for convergence will be guided by a test of statistical significance. If this test shows convergence and there is no additional candidate mixing variable, then the process proceeds to step 228. However, if the test of convergence fails or if there is another candidate mixing variable then the process continues to step 227.

In step 227, the current iteration of estimates is compared to a predetermined maximum number of steps. If the number of steps has not been exceeded, then the process returns to step 223 to develop another set of parameter estimates. If the number of iterations has been exceeded and there remains one or more additional mixing variables to be tested, then the process returns to step 222 and the next candidate mixing variable is selected. If the maximum iterations have been exceeded and no candidate mixing variable remains, then the process proceeds from step 226 to step 228.

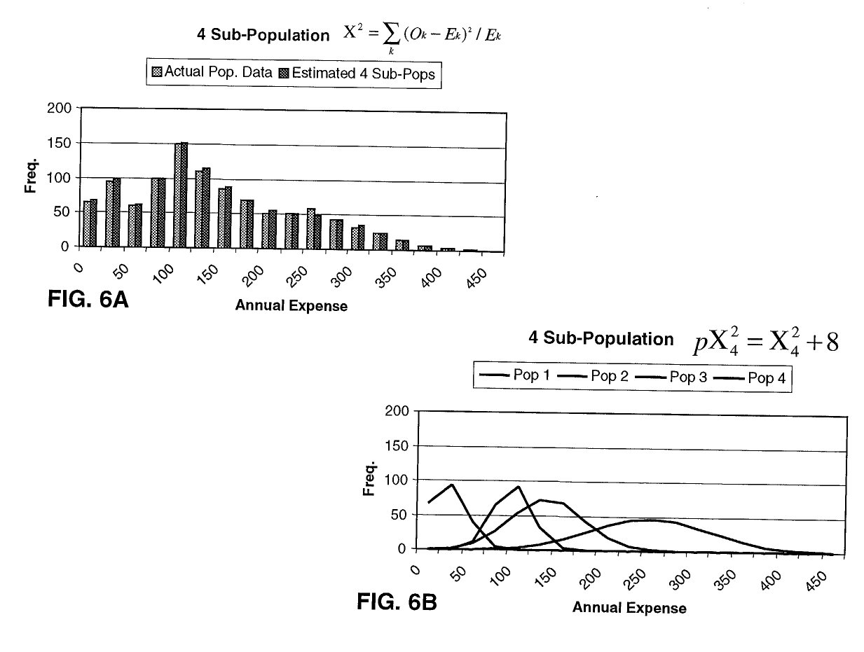

In step 228, the results of the various rounds of estimates are reviewed. The mixing variable and specific parameter estimates which correspond to the best-fit alternative are selected. This selection defines the number of sub-populations, the composition proportions of these sub-populations and relevant descriptive statistics of the sub-populations. FIG. 6 shows the resulting sample of values of a selected mixing variable comprising four sub-populations of distinct proportion and descriptive statistics.

In step 229, a stochastic assignment for each individual in the sample population is generated. This stochastic assignment may be of the form of a first-order stochastic dominance resulting in a univariate assignment to one of the estimated sub-populations. This stochastic assignment can also be represented by a vector of probabilities representing the likelihood of membership in each of the recognized sub-populations.

The stochastic assignments created in step 229 are incorporated into an augmented dataset at step 230. Once this augmented dataset is created, a secondary classification methodology is implemented. This secondary classification is directed by the results of the stochastic assignment. This secondary process can be implemented using any of a number of standard classification techniques know by those familiar with the art, such as Classification and Regression Trees (CART) or neural networks. In this process, trial classification rules are developed at step 231. This step begins a highly iterative and computationally extensive process which involves generating a wide range of hypothesized rules and then testing for validity with the stochastic estimates in the augmented dataset. For example, a first set of trial classification rules may be that all brown eyed females over 23 belong to sub-population “A”, all blondes under 5 belong to sub-population “B”, etc. Once this set of rules is applied, the rate of assignment is compared to the stochastic estimates used. In a subsequent round, the trial classification rules about blondes might be substituted for individuals of age of 4 or less.

Given these trial classification rules, step 232 generates estimated metrics for the resulting assignments. These metrics are compared to the augmented sample in step 233. The results of this comparison are checked for convergence in that the resulting value of some distance measure is compared to a predetermined critical value in step 234. If convergence is not detected, the process returns to step 231.

If convergence is detected in step 234, these final classification rules are used to assign individuals to appropriate sub-populations in step 235 completing the process.

The invention may be implemented as hardware, firmware or software or a combination of the three. However, preferably the invention is implemented as one or more computer programs executed by one or more processors in a programmable computer system. The programs may be stored in one or more of a random-access memory (RAM), a read-only memory (ROM) or storage media such as magnetic or optical disk. The programs are preferably implemented in a high level procedural or object-oriented programming language.

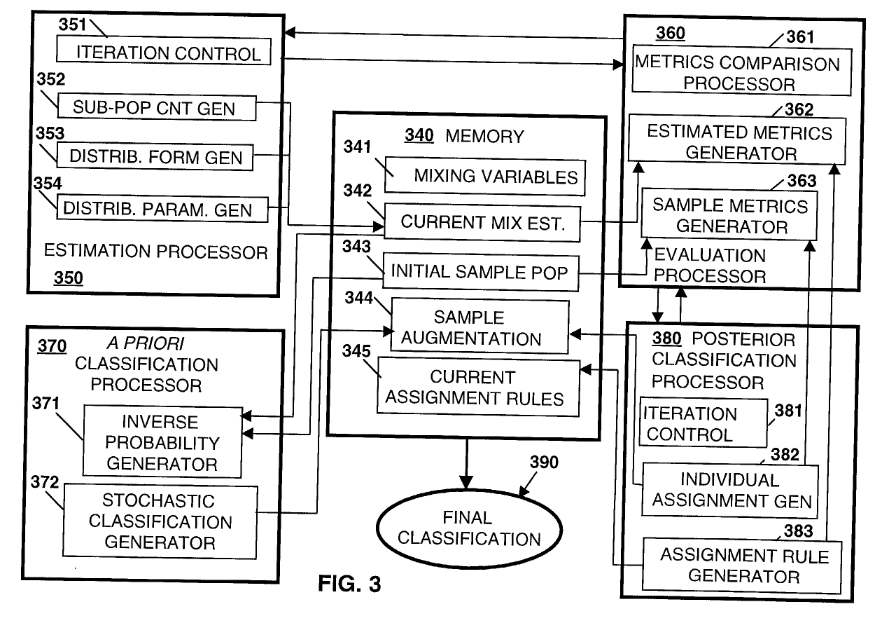

Referring to FIG. 3, a block diagram of a system for population classification is shown. It contains system memory 340 which works with four specialized processors; an estimation processor 350, an evaluation processor 360, an a priori classification processor 370, and a posterior classification processor 380 to produce final classification 390.

At the start of the process, the memory 340 is loaded with the initial population sample dataset 343. As the process continues, the additional aspects of the memory are populated including the candidate mixing variable 341 from step 222, the current mixture estimate 342 generated at step 223, the sample augmentation 344 generated at step 230 and the current assignment rules 345 generated at step 231. At the end of the process, this memory is output via data file, display, printer or other storage or output device to comprise the final classification 390.

Once the memory 340 has been loaded with the initial sample population dataset 343 from step 221, control is passed to the estimation processor 350. Coordinating this process is the iteration control 351 from step 226 which manages sequential revisions to current mixture estimate 342. These estimates are comprised of an estimated number of sub-populations produced by the sub-population count generator 352 at step 224, an estimated distribution form for each sub-population, for example, Normal Distribution, Log-normal Distribution which are created by the distribution form generator 353 also at step 224, and parameters appropriate to the estimated distribution form, such as mean and standard deviation as supplied by the distribution parameter generator 354 at step 224.

At the end of each successive iteration, the results of the estimation processor 350 are written back to the memory 340. The current mixture estimate 342 and the initial population sample 343 are passed to the evaluation processor 360. The current mixture estimate 342 is used as an input by the estimated metrics generator 362 from step 224 in FIG. 2, to create appropriate sufficient statistics to describe the estimate. The initial sample population 343 is used as input to the sample metrics generator 363 from step 221 in FIG. 2, to create comparable sufficient statistics for the sample. The metrics comparison processor 361 in step 225 evaluates these sets of sufficient statistics. The penalized Fuller Chi Square method is one example of a comparison tool that could be used in at this point. The operations of the evaluation processor 360 are controlled by the iteration control 351 in step 227. The results of the comparison calculated by the metrics comparison processor 361 are read back to the iteration control 351. If the value received by the iteration control 351 is less than a pre-established value, then the initial estimation processing is concluded. If the measure of difference supplied by the metrics comparison processor 361 exceeds the pre-established value, the iteration control 351 starts a new cycle through the estimation processor 350.

When the iteration control 351 of the estimation processor 350 achieves an estimate for the mixture which matches the initial population sample 343 within the pre-established limit, control is passed to the a priori classification processor 370. The a priori classification processor 370 is comprised of an inverse probability processor 371 from step 229 which assigns a probability value for each record in the initial sample population 343 based on the current mixture estimate 342. This probability value is used by the stochastic classification generator 372 from step 229 to make a preliminary classification assignment of each individual in the initial population estimate 343. In the simplest form, this assignment may be based on first order stochastic dominance where by the individual is assigned to the most likely individual of the current mixture estimate 342. In a more advanced form, this assignment would be in the form of a vector of probabilities representing the likelihood of membership of the given individual in each of the sub-populations contained in the current mixture estimate 342. The stochastic classification generator 372 writes its results to the memory 340 to be stored as part of the sample augmentation 344.

After completion of the a priori classification processor 370, control of the process is passed to the posterior classification processor 380. The posterior classification processor 380 can be an implementation of any appropriate pattern recognition or classification methodology. The posterior classification processor 380 is comprised of an iteration control module 381 from step 234 which allows repeated cycles to occur governing the passing of data among the posterior classification processor 380, the memory 340, and the evaluation processor 360. Within the posterior classification processor 380, the assignment rule generator 383 from step 231 develops trial assignment rules based on the data contained in the initial sample population 343 and the sample augmentation 344. These trial rules are passed to the estimated metrics generator 362 in step 232 to create appropriate sufficient statistics for the proposed classification rules. Concurrently, the individual assignment generator 382 from step 231 labels each observation as an individual of the correct sub-population in accordance with these rules. These rules are written to memory 340 as the current assignment rules 345. The individual assignment is written to memory 340 as part of the sample augmentation 344. The individual assignments are combined with the initial population sample 343 in the sample metrics generator 363 in step 232. The sample metrics generator 363 creates corresponding sufficient statistics including error boundaries, for the initial sample population 343 and the current assignment rules 345. These sufficient statistics are compared in the metrics comparison processor 361 in step 233.

The iteration control 381 from step 234 determines whether convergence has occurred and if not begins another cycle of the posterior classification processor 380. If the results of the metrics comparison processor 361 in step 235 are within a predetermined range, the process is halted and the current assignment rules 345 and sample augmentation 344 are returned to the practitioner via a display or output device or written to a magnetic or optical medium completing the classification. Each memory may have its information stored as objects, as database records, as spreadsheet records, or in other forms.

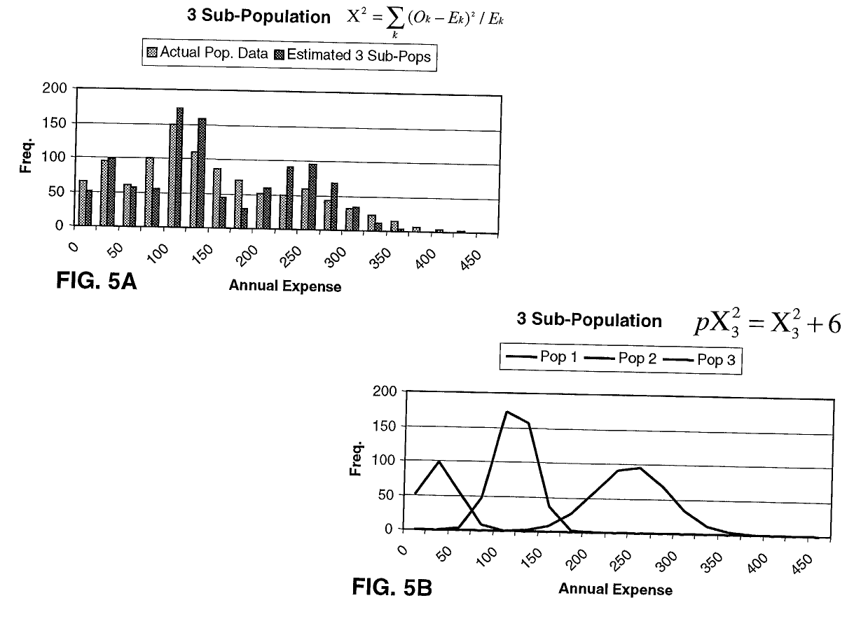

FIG. 4 through FIG. 7 show a representation of an example using the Fuller Penalized Chi Square statistic. In these figures the initial sample population is shown in histogram form in FIG. 4. In FIG. 5 through FIG. 7 sub-population mixtures of 3, 4 & 5 sub-populations have been generated to represent the initial population. Additionally each sub-population mixture is charted compared to the original population data for a visual representation of generating the Chi Squared factor. In Table 1 below, one sees that the lowest Chi Square value is 2.98 from the 5 sub-population mixture. However, when the penalty factor from the Fuller Penalized Chi Square statistic is included, the lowest penalized Chi Square value is 11.71 from the 4 sub-population mixture.

TABLE 1

| Sub pop | X² | penalized X² |
|---|---|---|
| 3 | 319.85 | 325.85 |
| 4 | 3.71 | 11.71 |
| 5 | 2.98 | 12.98 |

Each sub-population is characterized by a mean and variance parameter. The penalty factor increases as the complexity of the mixture increases. This allows use of the Fuller Penalized Chi Square statistic to accurately represent the optimal solution set for the evaluated number of sub-populations. This penalizing method provides a computationally efficient way to analyze and select the preferred estimated sub-population mixture to use in representing the population. In the example data represented in FIGS. 5-7 using the Fuller Penalized Chi Square allows selection of the 4 sub-population mixture as the optimal solution. However, without the penalty considered, the non-penalized Chi Square statistic is virtually always going to lead to selection of the largest number of sub-populations. Increasing the number of sub-populations is problematical because there is no factor to account for the substantial increase in complexity and/or errors introduced by the additional sub-populations is subsequent steps of population segmentation.

FIG. 5A shows Chi Square using 3 sub-populations calculated by:

$${X}^{2} = {\sum }_{k} {( {O}_{k} - {E}_{k} )}^{2} / {E}_{k}$$

Using the population example of FIG. 4, X² calculates to 319.85. The observed vs. expected results are graphed in FIG. 5A.

The penalized X² of FIG. 5B becomes 325.85 using the complexity factor for the 3 sub-population mixture. Penalized Chi Square (pX²) is defined as adjusting the Pearson Chi Square factor for the number of parameters and sub-populations being estimated. Mathematically it's represented as:

pX²=X²+G

Where G is a penalty factor proportional to the number of estimated parameters. Here G=2 parameters (mean & variance) *3 (number of sub-populations) or 6 as shown below.

pX₃²=X₃²+6

FIG. 6A shows Chi Square using 4 sub-populations. Using the population example of FIG. 4, X² calculates to 3.7 1. The observed vs. expected results are graphed in FIG. 6A.

The penalized X² of FIG. 6B becomes 11.71 using the complexity factor for the 4 sub-population mixture. Here G=2 parameters (mean & variance) *4 (number of sub-populations) or 8 as shown below.

pX₄²=X₄²+8

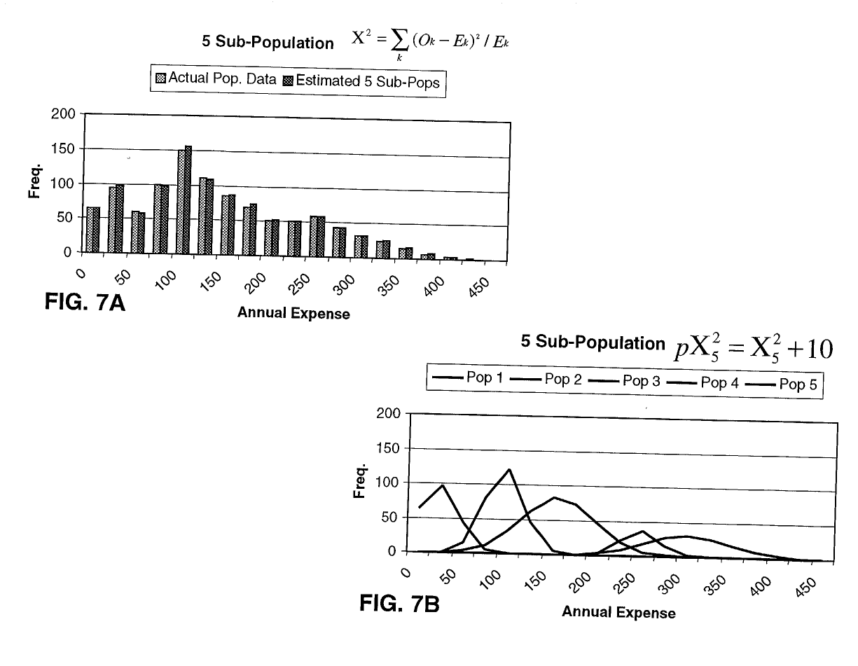

FIG. 7A shows Chi Square using 5 sub-populations. Using the population example of FIG. 4, X² calculates to 2.98. The observed vs. expected results are graphed in FIG. 7A.

The penalized X² of FIG. 7B becomes 12.98 using the complexity factor for the 5 sub-population mixture. Here G=2 parameters (mean & variance) *5 (number of sub-populations) or 8 as shown below.

pX₅²=X₅²+10

In these examples, the Chi Square method has the lowest complexity factor with 5 sub-populations while the penalized Chi Square method has the lowest complexity factor with 4 sub-populations. Thus, in this example the penalized Chi Square process would result in the selection of 4 sub-populations rather than the 5 sub-populations resulting from the Chi Square method.

Thus, what is provided is a method and system for population classification wherein the population is non-homogeneous having unknown attributes prior to classification.

What is claimed is:

1. In a non-homogenous sample population having a plurality of members, each member having a plurality of characteristics including at least one continuous variable characteristic common to the plurality of members of the sample population, a method of segmenting the sample population into sub-populations having substantially unknown attributes prior to segmentation, the method comprising the steps of:
determining sub-population parameters of a plurality of sub-populations of the sample population and sub-population provisional assignments for each of the plurality of members in response to the continuous variable characteristic;
augmenting the plurality of characteristics of each of the plurality of members with the corresponding sub-population provisional assignments;
developing assignment rules for each of the plurality of sub-populations in response to the determined sub-population parameters and at least some of the augmented plurality of characteristics; and
assigning each of the plurality of members of the sample population to one of the plurality of sub-populations in response to the assignment rules.

2. The method according to claim 1 wherein the sample population is a portion of a larger general population having a multiplicity of members and said step of assigning further assigns each of the multiplicity of members of the general population in response to the assignment rules.

3. The method according to claim 1 further comprising the step of predicting a future behavior of a sub-population in response to characteristics of members assigned to the sub-population.

4. The method according to claim 3 further comprising the steps of:
predicting a future behavior of each of the plurality of sub-populations in response to characteristics the correspondingly assigned members; and
predicting a future behavior of the sample population in response to predicted future behaviors of the plurality of sub-populations.

5. The method according to claim 4 further comprising the steps of: either adding or removing a member to or from the general population;
in response to adding the member, assigning the added member to one of the plurality of sub-populations in response to the assignment rules;
developing a revised prediction of a future behavior of the sub-population of the added or subtracted member; and
developing a revised prediction of a future behavior of the sample population in response to predicted future behaviors of the plurality of sub-populations.

6. The method according to claim 1 wherein said step of determining sub-population parameters further includes the steps of:
receiving a dataset indicative of the plurality of characteristics of the plurality of members;
using a statistical process to produce the plurality of sub-population parameters in response to the continuous variable characteristic; and
optimally selecting a plurality of sub-populations in response the dataset.

7. The method according to claim 6 wherein said step of determining develops statistically valid estimates of an optimum number of sub-populations.

8. The method according to claim 6 wherein the sub-populations have mixing proportions and said step of determining develops statistically valid estimates of mixing proportions of the sub-populations.

9. The method according to claim 6 wherein the sub-populations have parametric estimates and said step of evaluating develops statistically valid parametric estimates of each of the sub-populations.

10. The method according to claim 6 wherein the statistical process includes a Fuller Penalized Chi Square statistical process for analyzing a finite mixture population to account for a number of parameters and sub-populations derived from the population, the Fuller Penalized Chi Square statistical process represented as:
pX²=X²+G
where G=a penalty factor proportional to the # of estimated parameters
wherein Chi Square is represented as:
$${X}^{2} = {\sum }_{k} {( {O}_{k} - {E}_{k} )}^{2} / {E}_{k}$$
where:
Oₖ=Observed samples in block k, k=1 to r
Eₖ=Expected samples in block k, k=1 to r
r=# of blocks in the histogram
k=# of sub-populations
and the method further comprises the steps of:
evaluating a number of sub-populations estimates using the Penalized Fuller Chi Square method; and
deriving an optimal solution for the evaluated number of sub-populations.

11. The method according to claim 1 wherein the plurality of characteristics include at least a first and a second continuous variable characteristic, and said step of determining sub-population characteristics further includes the steps of:
receiving a dataset indicative of characteristics of the plurality of members;
using a statistical process to produce a first plurality of sub-population parameters in response to the first continuous variable characteristic;
optimally selecting a first plurality of sub-populations in response the first plurality of sub-population parameters;
using the statistical process to produce a second plurality of sub-population parameters in response to the second continuous variable characteristic; and
optimally selecting a second plurality of sub-populations in response the second plurality of sub-population parameters; and
optimally selecting between the first and second plurality of sub-populations.

12. The method according to claim 1 wherein said step of determining sub-population provisional assignments determines the provisional assignments by a classification process.

13. The method according to claim 1 wherein the sub-populations resulting from said step of assigning are substantially not non-homogenous, the method further including the steps of:
developing statistically valid mixing proportions and parametric estimates of each sub-population for forecasting a behavior response characteristic of each sub-population; and
developing and a statistically valid confidence interval around the forecast behavior.

14. A Fuller Penalized Chi Square method for analyzing a finite mixture of a sample population to account for a number of parameters of sub-populations derived from the sample population wherein the Fuller Penalized Chi Square method is represented as:
pX²=X²+G
where G=a penalty factor proportional to the # of estimated parameters
wherein Chi Square is represented as:
$${X}^{2} = {\sum }_{k} {( {O}_{k} - {E}_{k} )}^{2} / {E}_{k}$$
where:
Oₖ=Observed samples in block k, k=1 to r
Eₖ=Expected samples in block k, k=1 to r
r=# of blocks in the histogram
k=# of sub-populations
and the method comprises the steps of:
generating a number of sub-population estimate sets using the Fuller Penalized Chi Square method;
deriving an optimal solution for the generated number of sub-populations estimate sets; and
selecting one of the sub-population estimate sets in response to the optimal solution.

15. The method according to claim 14 wherein said step of deriving selects a minimal valid number while substantially avoiding issues of model overfit.

16. The method according to claim 14 wherein said step of evaluating develops statistically valid estimate of an optimum number of sub-populations.

17. The method according to claim 14 wherein the sub-populations have mixing proportions and said step of evaluating develops a statistically valid estimate of mixing proportions of the sub-populations.

18. The method according to claim 14 wherein the sub-populations have parametric estimates and said step of evaluating develops statistically valid parametric estimates of each sub-population.

19. The method according to claim 14 wherein the sample population has a plurality of members, each member having a plurality of characteristics and the method is further for segmenting the members of the sample population into a plurality of sub-populations, the method further comprising the steps of:
determining sub-population provisional assignments for each of the plurality of members and sub-population parameters for the selected sub-population estimate set of said step of selecting;
augmenting the plurality of characteristics of each of the plurality of members with the corresponding sub-population provisional assignments;
developing assignment rules for each of the plurality of sub-populations in response to the sub-population parameters and at least some of the plurality of augmented characteristics of the plurality of members; and
assigning the plurality of members of the sample population to one of the plurality of sub-populations in response to the assignment rules.

20. In a non-homogenous sample population having a plurality of members, each member having a plurality of characteristics including at least one continuous variable characteristic common to the plurality of members of the sample population, a device for segmenting the sample population into sub-populations having substantially unknown attributes prior to segmentation comprising:
an estimation processor for determining sub-population parameters of a plurality of sub-populations of the sample population and sub-population provisional assignments for each of the plurality of members in response to the continuous variable characteristic;
an a priori classification processor for augmenting the plurality of characteristics of each of the plurality of members with the corresponding sub-population provisional assignments; and
a posterior classification processor for developing assignment rules for each of the plurality of sub-populations in response to the determined sub-population parameters and at least some of the augmented plurality of characteristics of the plurality of members.

21. The apparatus of claim 20 further comprising
an evaluation processor for utilizing a statistical process to produce a plurality of sub-population characteristics in response to the continuous variable characteristic and for optimally selecting a plurality of sub-populations in response the plurality of sub-population characteristics wherein the statistical process includes a Fuller Penalized Chi Square statistical process for analyzing a finite mixture population to account for a number of parameters and sub-populations derived from the population, the statistical method being represented as:
pX²=X²+G
where G=a penalty factor proportional to the # of estimated parameters
wherein Chi Square is represented as:
$${X}^{2} = {\sum }_{k} {( {O}_{k} - {E}_{k} )}^{2} / {E}_{k}$$
where:
Oₖ=Observed samples in block k, k=1 to r
Eₖ=Expected samples in block k, k=1 to r
r=# of blocks in the histogram
k=# of sub-populations.
